(19) United States
(12) Patent Application Publication
(10) Pub. No.: US 2003/0096622 A1
(43) Pub. Date: May 22, 2003

(54) Locating a wireless station

(76) Inventor: Jani Moilanen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/221,619

(22) PCT Filed: Feb. 27, 2001
(86) PCT No.: PCT/EP01/02224

(30) Foreign Application Priority Data
Mar. 15, 2000 (GB) 0006297.6

(51) Int. Cl. H04Q 7/20; H04B 7/00

(52) U.S. Cl. 455/456; 455/517

(57) ABSTRACT

The present invention relates to provision of location information concerning a wireless station of a communication system. In accordance with the method, at least one location measurement is accomplished by an element that associates with the communication system. An estimate for the location of the wireless station is defined based on the at least one measurement. The estimate is subjected to a non-linear measurement error minimisation routine to determine more accurate location of the wireless station.

### FIELD OF THE INVENTION

The present invention relates to location services, and in particular, but not exclusively, to provision of information concerning geographical location of a wireless station of a cellular telecommunications system

### BACKGROUND OF THE INVENTION

A cellular telecommunications system is based around cells or similar radio coverage and/or service areas. Examples of cellular telecommunications systems include standards such as the GSM (Global System for Mobile communications) or various GSM based Systems (such as GPRS: General Packet Radio Service), AMPS (American Mobile Phone System) or DAMPS (Digital AMPS) or WCDMA (Wideband Code Division Multiple Access) and TDMA/CDMA (Time Division Multiple Access/Code Division Multiple Access) in UMTS (Universal Mobile Telecommunications System), IMT 2000 and so on.

In cellular systems, a base transceiver station (BTS) serves mobile stations (MS) or similar wireless user equipment (UE) via an air or radio interface. A base station provides a coverage area can be defined as a certain geographically limited area referred to as a cell. The size and shape of the cells may vary from cell to cell. Several cells may also be grouped together to form a larger service area.

Each of the cells can be controlled by an appropriate controller apparatus. For example, in the WCDMA radio access network the base station (which may be referred to as Node B) is connected to and controlled by the radio network controller (RNC). In the GSM radio network the base station may be connected to and controlled by a base station controller (BSC) of a base station subsystem (BSS). The BSC/RNC may be then connected to and controlled by a mobile switching center (MSC). Other controller nodes may also be provided, such as a serving GPRS support node (SGSN). The MSCs of a cellular network are interconnected and there may be one or more gateway nodes connecting the cellular network e.g. to a public switched telephone network (PSTN) and other telecommunication networks such as to the Internet and/or other packet switched networks. The mobile station may also be in communication with two or more base stations of the system at the same time. The two or more base stations may be connected to the same controller or different controllers.

The cellular network apparatus can also be employed for provision of location information concerning a mobile station and the user thereof. More particularly, the cells or similar geographically limited service areas facilitate the cellular telecommunications system to produce at least a rough location information estimate concerning the current geographical location of a mobile station, as the cellular telecommunications system is aware of the cell with which a mobile station currently associates. Therefore it is possible to conclude from the location of the cell the geographical area in which the mobile station is likely to be at a given moment. This information is available also when the mobile station is located within the coverage area of a visited or “foreign” network. The visited network may be capable of transmitting location information of the mobile station back to the home network, e.g. to support location services or for the purposes of call routing and charging.

A location service feature may be provided by a separate network element such as a location server which receives location information from at least one of the controllers of the system. For example, in the GSM a Visitor Location Register (VLR) of the visited MSC or the Home location Register (HLR) of the home network may provide the location server with the required information. If no further computations and/or approximations are made, this would give the location to an accuracy of one cell, i.e. it would indicate that the mobile station is (or at least was) within the coverage area of a certain cell.

However, more accurate information concerning the geographical location of a mobile station may be desired. For example, the United States Federal Communication Commission (FCC) has mandated that wireless service providers have to implement location technologies that can locate wireless phone users who are calling to E911 emergency centre. Although the FCC order is directed to emergency caller location, other (commercial and non-commercial) uses for mobile systems, such as fleet management, location-dependent billing and navigation, might also find more accurate location information useful.

More accurate location information may be obtained through e.g. by calculating the geographical location from range or range difference (RD) measurements. All methods that use range difference (RD) measurements may also be called TDOA (time difference of arrival) methods (mathematically RD=c*TDOA, wherein c is the signal propagation speed). Observed time difference (OTD), E-OTD (Enhanced OTD) and TOA (time of arrival) are mentioned herein as examples, of technologies that are based on the RD measurements. The difference between the TOA (time of arrival) and the E-OTD is in that in the TOA the mobile station sends the signal and network makes the measurements, whereas in the E-OTD the network sends the signals and the mobile station measures them. It is also possible to form RD measurements based on other sources, e.g. from GPS pseudo-range measurements.

More particularly, the reliability of the location determination may be improved by utilising results of measurements which define the travel time (or travel time differences) of the radio signal sent by the mobile station to the base station. The measurements are accomplished by a number (preferably at least three) base stations covering the area in which the mobile station is currently located The measurement by each of the base stations gives the distance (range) between the base station and the mobile station or distance difference (range difference) between the mobile station and two base stations. Each of the range measurements generates a circle that is centered at the measuring base station, and the mobile station is determined to be located at an intersection of the circles Each of the range difference measurement by two base stations creates a hyperbola (not a circle as in the range measurements). Thus if range differences are used in the location calculation, the intersections of the hyperbolas are searched for. In an ideal case and in the absence of any measurement error, the intersection of the circles or the hyperbolas would unambiguously determine the location of the mobile station

In principle, in the hyperbolic case two hyperbolas (i.e., measurements from three different sites), and in the circular case two circles (i.e., measurements from two different sites) are enough for location estimation. However, two circles/hyperbolas can intersect twice, which means that in ideal case, measurement from one more site is needed for unambiguous solution unless some priori information is available which is good enough to reject the wrong solution.

However, the measurements may only rarely be accomplished in ideal conditions and will practically always include some degree of an error. The error may be caused e.g. by a blocking in the direct radio propagation path between the transmitting and receiving stations. This non-line of sight (NLOS) phenomenon is known to be one of the major sources of error in position location because it causes the mobile station to appear further away from the base station than it actually is For example, in a dense urban environment several obstacles may cause the mobile station to repeatedly and/or continuously lose the direct line of sight with one or several of the base stations. The NLOS causes an increased path length the radio signal has to travel between the transmitting station and the receiving station in order to circumvent all the obstructing elements. Reflections and/or diffraction may also cause error. Thus the first arriving wave may travel excess path lengths on the order of hundreds of metres if the direct path is blocked. Incorrect location information may also be caused by multipath propagation, synchronisation errors, measurement errors, errors in RTT (Round Trip Time) determination and so on. Therefore, if three or more circles/hyperbolas are used for the location estimation, the circles or hyperbolas may not intersect in a same point due to the measurement error. It is also possible that circles/hyperbolas do not intersect at all because of measurement errors.

In the RD measurement based methods the difference of signals' arrival times between a mobile station MS and two base stations (BTSs) is measured at a time, resulting to a hyperbola (see FIG. 1). A second measurement employing a third base station will result to another hyperbola. Mathematically this can be defined as follows If we have RD measurements between N base stations BTS, say BTS1, . . . , BTSN, co-ordinates of the mobile station MS can be calculated from equation set

RDᵢⱼ=∥xᵢ−x∥−∥xⱼ−x∥,i,j ε{1 . . . N (1)

where

xᵢ,xⱼ present co-ordinates of the ith and jth BTSs,

RDᵢⱼ presents the range difference measurement between said BTSs,

N present the number of base stations employed in the determination, and

x presents the unknown co-ordinates of the mobile station.

It should be appreciated that in the above the term ‘x’ may designate the x and y co-ordinates, and possibly also z co-ordinates.

As explained above, the location system implementations may include measurement errors. Therefore equation set (1) may not have realistic solutions. I.e. the equation (1) may provide more than one intersection or may not provide solution at all in an over-determined case, that is where more than N base stations are employed in the RD based determination, N denoting the dimension of the space where location estimate is calculated (e.g. N=2 or 3).

Several attempts to solve the non-linear function have been introduced. Closed-Form Least-Squares Location Estimation from Range-Difference Measurement and Position-Location Solutions by Taylor-Series Estimation are mentioned herein as examples of the prior art methods. However, since minimisation of the error in the location determination may require minimisation of a non-linear function, the prior art methods have been based on some kind of approximations. The approximations are usually based on linearisation of the problem. Therefore they may not be optimal for all location applications. In addition, the former methods may not use prior information to define the area of interest. This can result in suboptimal (sometimes even unrealistic) solutions

### SUMMARY OF THE INVENTION

It is an aim of the embodiments of the present invention to address one or several of the disadvantages and/or shortcomings of the prior art location services.

According to one aspect of the present invention, there is provided a method in a communication system for providing location information of a wireless station, the method comprising: accomplishing at least one measurement that may be used for determining the location of the wireless station by an element that associates with the communication system; defining an estimate of the location of the wireless station based on the at least one measurement, wherein the estimate is defined by using at least one approximation; subjecting the estimate to a non-linear measurement error minimisation routine; and outputting location information of the wireless station based on the results of the minimisation routine.

According to another aspect of the present invention there is provided a location system that associates with a cellular communication system for providing location information of a wireless station of the cellular communication system, the system comprising: an element that associates with the cellular communication system for accomplishing at least one measurement that may be used for determining a location estimate for the wireless station; a controller for defining the location estimate for the wireless station based on the at least one measurement, wherein the controller is adapted to use at least one approximation for the estimate, and for subsequently subjecting the estimate to a non-linear measurement error minimisation routine; and interface means for outputting location information of the wireless station based on the results of the minimisation routine.

According to another aspect of the present invention there is provided a wireless station for a communication system, the wireless station comprising: means for handling information concerning at least one measurement that relates to the location of the wireless station; a controller for defining a location estimate for the wireless station based on the information concerning the at least one measurement, the controller being adapted to subject the estimate to a non-linear measurement error minimisation routine; and interface means for outputting location information of the wireless station based on the results of the minimisation routine.,

In the embodiments of the various aspects of the invention the minimisation routine may use at least one weighted value that is proportional to the reliability of the respective measurement. The reliability may be defined based on dispersion of the measurements. The minimisation routine may also comprise an additional weight function that is adapted to increase the value of a minimized function for locations that are outside of a predefined area of interest.

The embodiments of the invention may provide a location service that may be capable of outputting more accurate location information than location services that are not employing the embodiments. It may also be possible to find a location estimate even if there is only two hyperbolas or circles which will not intersect due to the measurement errors.

### BRIEF DESCRIPTION OF DRAWINGS

For better understanding of the present invention, reference will now be made by way of example to the accompanying drawings in which:

FIG. 1 shows one embodiment of the present invention;

FIG. 2 shown another embodiment of the present invention;

FIG. 3 is a flowchart illustrating the operation of one embodiment of the present invention;

FIGS. 4a and 4b show test results for some embodiments of the present invention; and

FIG. 5 shows Tables 1 and 2 illustrating test results for further embodiments.

### DESCRIPTION OF PREFERRED EMBODIMENTS OF THE INVENTION

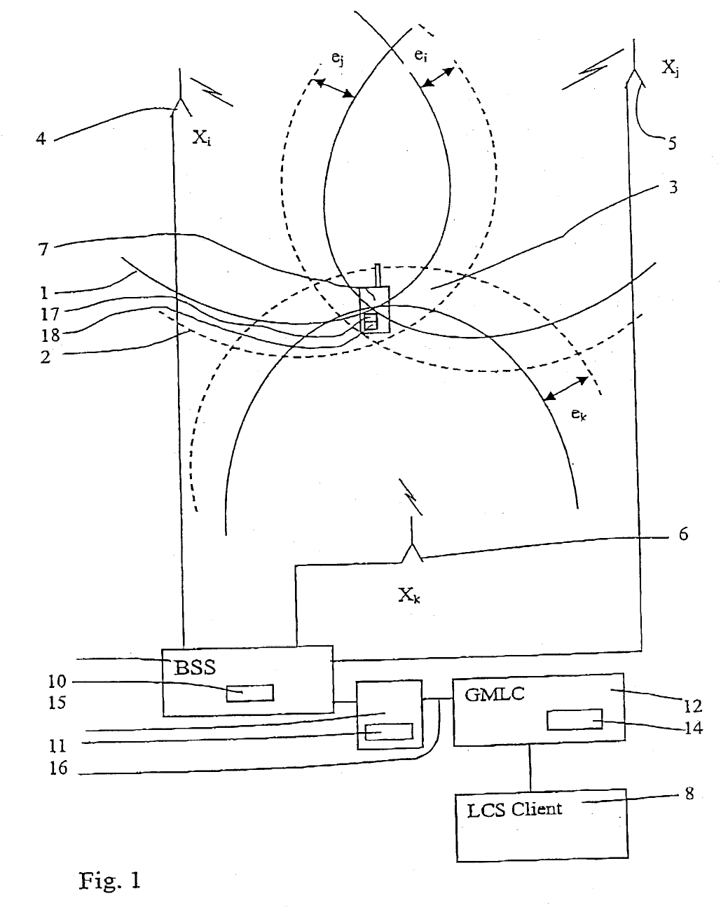

Reference will first be made to FIG. 1 in which three base stations provide three radio coverage areas or cells of a cellular telecommunications network Even though the exemplifying telecommunications network shown and described in more detail uses the terminology of the GSM (Global System for Mobile telecommunications) public land mobile network (PLMN), it should be appreciated that the proposed solution can be used in any cellular system, such as in the 3^{rd} generation WCDMA (Wideband Code Division Multiple Access) UMTS (Universal Mobile Telecommunications System) that provides communications between a mobile station and a base station and some kind of location information service.

In FIG. 1 each cell is served by the respective base station (BTS) 4, 5 and 6. More particularly, each base station is arranged to transmit signals to and receive signals from the mobile station (MS) 7. Likewise, the mobile station 7 is able to transmit signals to and receive signals from the respective base station. The mobile station 7 accomplishes this via wireless communication with the base stations. Typically a number of mobile stations will be in communication with each base station although only one mobile station is shown in FIG. 1 for clarity. Each of the base stations may provide an omnidirectional radio coverage area or a sector radio beam provided with a directional or sector antenna (not shown). The sector base station may use e.g. three 120° directional antennae whereby three radio coverage areas are provided, or four 90° directional antennas providing four radio coverage areas and so on, or any combinations of different radio coverage beam widths. It should also be appreciated that base stations may sometimes be referred to as node B (e.g. in the UMTS standard). It should also be appreciated that one cell may include more than one base station and that base station apparatus may provide more than one cell.

The geographical location of the base stations is known The location co-ordinates of the base stations 4, 5 and 6 are shown to be Xᵢ, Xⱼ and Xₖ, respectively. The unknown location co-ordinates of the mobile station 7 are designated by X.

The geographical location of the base station and/or the mobile stations may be defined, for example, in X and Y co-ordinates or in latitudes and longitudes. It is also possible to define the location of the base stations and/or mobile stations in vertical directions. For example, Z co-ordinate may be used when providing the location information in the vertical direction. The vertical location may be needed e.g. in mountainous environments or in cities with tall buildings.

Each of the base stations is connected to a network controller 10, which in the exemplifying PLMN system is a base station controller (BSC) of a GSM radio access network. The BSC may also be referred to as base station subsystem. It should be appreciated that typically more than one controller is provided in a network. The controller 10 is typically connected to other network elements, such as to a mobile switching center MSC 11 and a SGSN via suitable interconnections.

The mobile station 7 is able to move within the cell and also from one cell coverage area to another cell coverage area. The location of the mobile station 7 may thus vary in time as the mobile station is free to move within the service area of the system

FIG. 1 also shows a location services (LCS) node 12 providing location services for different applications or clients 8. In general terms, the LCS node can be defined as an entity capable of providing information concerning the geographical location of a mobile station, and more particularly, the geographical location defined on the basis of the position of the mobile station relative to the base station(s) of the mobile telecommunications network. In the embodiment of FIG. 1 the node 12 comprises a gateway mobile location center (GMLC) that is provided in the core network side of the telecommunications system. A more detailed description of a possible location server can be found, for example, from ETSI (European telecommunications Standards Institute) technical specification “Location Services” (3GPP TS23.171 and GSM 03.71). The document is incorporate herein by reference.

The location service node 12 is implemented in the core network and is arranged to receive predefined information concerning the location of the mobile station 7 from the radio access network via MSC and/or SGSN 11 connected by the appropriate interface means 13 to the access network. The information received by the location server 12 may include the identity of the mobile station 7 and the identity of the cell, or the identity of the service area (containing one cell or several cells), that is serving the mobile station and the RD measurement results. The server 12 processes this information and/or some other predefined parameters and/or computes by processor means 14 appropriate calculations for determining and outputting the geographical location of the given mobile station 7. The location server 12 may be arranged to request for the location information and/or the information may be “pushed” from the PLMN network side to the server. In addition, the location server 12 may define the accuracy that is desired. The required accuracy may be indicated e.g. by so called quality of service (QoS) parameters included in a location information request.

It should be appreciated that the elements of the location service functionality may be implemented anywhere in the telecommunications system and that the actual location service implementation may be distributed between several elements of the system.

The LCS client 8 is a logical functional entity that makes a request to the LCS server node 12 for the location information of one or more target mobile stations. The LCS client 8 may be an entity that is external to the PLMN. The client 8 may also be an internal client (ILCS) i.e. reside in any entity (including a mobile station) within the PTMN. The LCS clients are entitled to receive at least some degree of information concerning the location (or location history) of the mobile station 7. The LCS server node 12 obtains positioning information from the access network side that is obtained using one or more of the appropriate techniques that will be briefly discussed below or any other suitable technique. This information may be processed in a predefined manner and is then provided to the LCS client 8.

The particular requirements and characteristics of a LCS client 8 are preferably known to the LCS server by its LCS client subscription profile. The particular LCS-related restrictions associated with each target mobile station may also be detailed in the target mobile station subscription profile. The LCS Server 12 may also enable a network operator to charge LCS clients for the LCS features that the network operator provides.

The LCS server node 12 may consists of a number of location service components and bearers needed to serve the LCS clients 8. The LCS server node 12 may provide a platform which will enable the support of location based services in parallel with other telecommunication services such as speech, data, messaging, other teleservices, user applications and supplementary services. The LCS server node 12 responds to a location request from a properly authorised LCS client 8 with location information for the target mobile stations specified by the LCS client a if considerations of target mobile station privacy are satisfied. The LCS Server 12 may thus provide the client 8, on request, the current or most recent geographic location (if available) of the target mobile station or, if the location fails, an error indication and optionally the reason for the failure.

It should be appreciated that the above described location service is only an example of the location services, and that the embodiments of the invention may also be employed in other types of location systems. For example, at least a part of the location determination process may be accomplished by the mobile station.

Each of the base stations 4 to 6 of FIG. 1 is shown to provide two range difference (RD) measurement hyperbolas 1 and 2. The “ideal” hyperbola is illustrated by the solid line 1 and the “real” hyperbola is illustrated by the dashed line 2. The difference between the respective pairs of hyperbolas, i.e. the error between the “ideal” and “real” hyperbolas 1 and 2 in the respective measurements, is designated by eᵢ, eⱼ and eₖ, respectively. As can be seen from FIG. 1, the real hyperbolas 2 do not intersect in a common location, but indicate only a location area 3 within which the mobile station 7 may be. Therefore the equation 1 discussed above may not produce any solution.

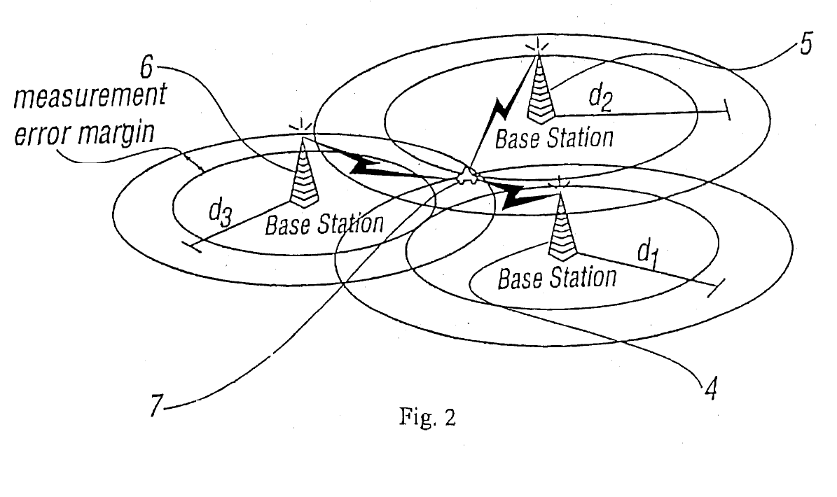

FIG. 2 illustrates the same problem, but instead of disclosing hyperbolas provided by range difference measurements, FIG. 2 illustrates three circles that are based on range measurements by three base stations 4 to 6.

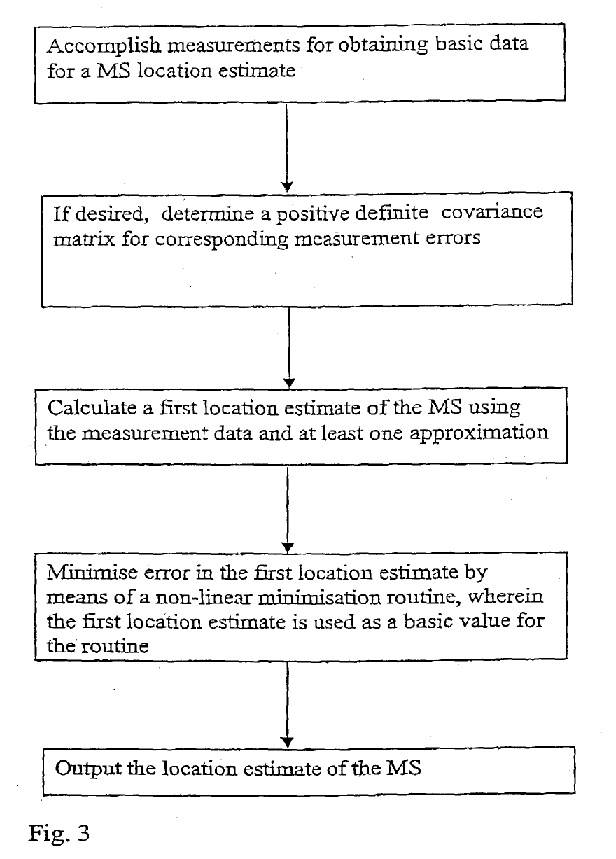

Reference in now made also to the flowchart of FIG. 3. In the embodiments the location determination is preferably divided into two subsequent steps. According to an embodiment a first location estimate is calculated from the measurements by the base stations (or by the mobile station) with some conventional location calculation method based on one or more approximations. The conventional method may be, for example, based on any least squares method, passive localisation algorithms, Taylor-series estimations and so on.

In an embodiment of the invention following cost function is formed

g(x)=e(x)^{T}·N^{31 1}·e(x) (2)

where e is a vector consisting of the equation errors,

x is the unknown location (e.g. in x and y co-ordinates), and

N is an estimate of the covariance matrix of the measurement errors.

eᵢ(x)≡RDᵢⱼ−(∥xᵢ−x∥−∥xⱼ−x∥),i≠j (3)

where j denotes the reference BTS,

RDᵢⱼ the range difference measurement between ith BTS and the reference BTS, and

xᵢ and xⱼ represent the locations of the base stations (e.g. in x,y co-ordinates).

If circles are used instead of the hyperbolas, the equation error may be defined as:

eᵢ(x)≡Rᵢ−∥xᵢ−∥ (4)

where Rᵢ denotes the measured range.

The above equations refer to euclidean norm, i.e. the distance between two points (that is, the distance between MS and BTS).

The result of the initial estimation that has been obtained by linear estimation may then be used as an initial value for a multi-dimensional non-linear minimisation routine in order to minimise the error in the equation.

Furthermore, an additional term, say s(x), can be added resulting to a cost function

ƒ(x)=g(x)+s(x) (5)

The covariance matrix can be estimated based on quality values for the measurements. The quality may depend e.g. on the dispersion of the range (difference) measurements and/or be based on any data that reflects the reliability/quality of the measurements. The dispersion appears in the measurements which are processed into one final measurement value. For example, in the E-OTD, the mobile station may make several OTD measurements, say OTD1, OTD2, OTD3, . . . , OTDn for a certain BTS pair (say BTSi, BTSj) and reports only one value based on those (raw) measurements. The mobile station may also report a quality figure which May be the dispersion of those (raw) measurements.

The relation between the weight and the reliability may be defined e.g. in the network planning stage. Some telecommunication standards, such as the GSM, define some reliability values for the measurements. The relation may be changed and/or updated anytime to correspond the latest defined quality of the measurements.

The additional weight function s(x) may be added to the weighted error function. The additional function s(x) is preferably a positively valued weight function. The s(x) function may have a relatively large values if the location x is not in the area of interest, for example if the mobile station is not located within the cell coverage area of the serving BTS. If two circles are generated by the range measurements, it may be possible to limit the other intersection point by an appropriate s(x) function.

The purpose of the s(x) function is to avoid finding local minimum far from the area of interest. The function may define a location determination window indicating the area of interest, whereby other areas become as excluded areas. Therefore any locations that are outside the window are excluded from the subsequent computations. The form of the s(x) function will depend on conditions of the area of interest, such as on the shape of the area under consideration.

The required computations may be accomplished at the base station subsystem 10, e.g. by the processor 15. The computations may also be accomplished at the MSC 11 by the processor unit 16. The processor 14 of the GMLC 12 may also accomplish part or all of the required computations. It is also possible to provide the network with a separate processing unit (not shown) adapted to perform the required processing of measurement data.

A possibility is to accomplish the computations at the mobile station 7, e.g. by a controller unit 17 thereof. The mobile station may receive all or part of the required information from the network side via its antenna. The received information may comprise information such as the location co-ordinates of the base stations and/or information that relates to at least one measurement by a location measurement unit of the network system. The received information may be handled directly by the controller 11 or it may be preprocessed and/or buffered by another controller unit 18. The mobile station may also perform at least one of the measurements, such as one or several E-OTD measurements or GPS measurements, e.g. by means of the unit 18. The computed location information may be output from the wireless station via the antenna and the wireless link between the mobile station and a base station of the communication system.

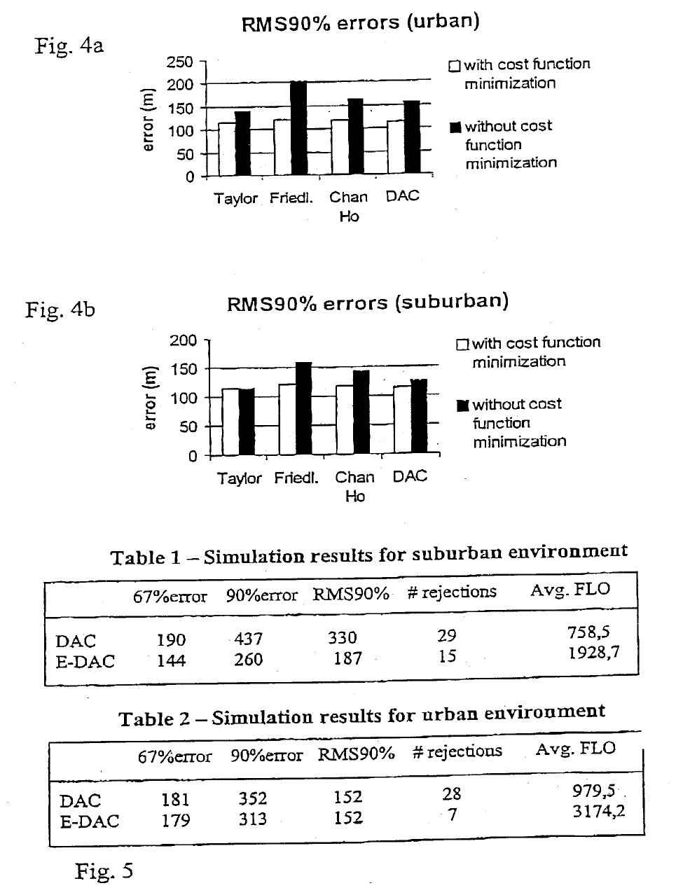

FIGS. 4a and 4b show test results obtained by testing the above described two step embodiment in a real GSM network. The test was performed using different kinds of location calculation algorithms for the first step. An E-OTD Trial system by Nokia Networks Oy was employed to gather the measurement data. The mobile station MS and a DGPS (Differential Global Positioning System) equipment were installed into a car which was moved around a test area. The DGPS was used to obtain an accurate comparison value for the location determination by the tested embodiments. The velocity of the car varied between 10-40 km/h during the tests.

The test was performed in two different types of test areas. The first area was a test for an urban area, and the results for this are shown in FIG. 4a. In the urban area, the typical cell size was in the range of 300-500 meters and the buildings had usually four to six floors. The results shown in FIG. 4b were obtained for a suburban area. In the suburban area the cell size was in the rabge of 500-3000 meters and the buildings had one or two floors. The size of the test area was approximately four square kilometers in the urban area and five square kilometers in the suburban area. The data received from the field tests were stored as text files so that the same measurement data could be used to simulate the performance of different estimation algorithms. This was made in order to ease the comparison of the results to each other.

The data received from the urban test area contained measurements for 650 locationings. The data from the suburban area contained 587 measurements. The data used for a single location calculation included the RD values, coordinates for the corresponding BTSs, and the real location coordinates (i.e, the DGPS measurements). No quality estimates for the RD values were available, and thus an identity matrix was used as the covariance matrix N.

Four different location calculation algorithms were used with Matlab™ programming language for the first step. The location estimation algoriths are defined in more detail in publications:

[1] Wade H. Foy, “Position-Location Solutions by Taylor-Series Estimation”, IEEE Transactions on Aerospace and Electronic Systems, VOL. AES-12, NO. 2, March 1976;

[2] Benjamin Friedlander, “A Passive Localization Algorithm and Its Accuracy Analysis”, IEEE Journal of Oceanic Engineering, VOL. OE-12, NO. 1, January 1987;

[3] Y. T. Chan, K. C. Ho, “A Simple and Efficient Estimator for Hyperbolic Location”, IEEE Transactions on Signal Processing, VOL. 42, NO. 8, August 1994; and

[4] J. S. Abel, “A Divide and Conquer Approach to Least-Squares Estimation.”, IEEE Transactions on Aerospace and Electronic Systems, VOL. 26, NO. 2, March 1990.

The effect of cost function minimization was tested by calculating location estimates with and without cost function minimization, i.e. the above referred second step. Matlab™ fmins was used as a minimization routine.

RMS90% error (root-mean-square for 90% of the smallest errors) was used for accuracy comparison (see FIGS. 4a and 4b) and Matlab™ flops counter was used to estimate the complexity.

Results show that the use of a cost function minimization may improve the accuracy of location determination. As shown by FIG. 4a, improvement is more evident in the more errorneous (urban area) data. As a drawback, the average number of floating point operations used per location estimation was roughly an order higher. However, Matlab™ fmins may not be especially efficient minimization routine (it is based on Nelder-Mead simplex search) and therefore it is likely that a better minimization routine may reduce this increment in complexity significantly.

The test employed the Simplex minimisation routine. It should be appreciated that any other appropriate minimisation routine, such as Powell's method or conjugate gradient method, may employed for the minimisation. In addition, involution of one or several of the terms may not be necessary in the non-linear minimisation routine, but the minimisation may be based, for example, on absolute values of the errors. The selection of the appropriate minimisation routine is an implementation issue.

It shall also be possible for the location determining process to make use of several sources of information in determining the location. Propagation and deployment conditions may limit the number or quality of measurements or additional measurements may be possible. Some mobile stations may also have additional (independent) sources of position information. The LCS shall be capable of making use of the restricted or the extra information as appropriate for the service being requested. The accuracy of the location determination may thus be improved further by utilising results of the various location measurement and/or determination techniques. The additional information may be obtained from a reliable external source, e.g. from the well known satellite based GPS (Global Positioning System). More accurate location information can be obtained through a differential GPS. In addition to the GPS, any other similar system capable of providing reliable location information can be used for this.

The following will discuss a further embodiment for improving the accuracy of the location measurements. More particularly, the following will discuss an enhanced divide and conquer method (E-DAC) that may be used for the first step of the above discussed location estimation algorithm. In the above referred document [4] J. S. Abel introduced a general divide and conquer (DAC) solution for the least-square estimation problem. In this approach the above discussed equation set (1) is divided into a number of (possibly overlapping) subsets. Each of the subsets has size that equals to the number of unknowns. Each subset is solved individually resulting intermediate results. Solution to the original equation set may be achieved by combining the intermediate results.

For example, if there is an equation set with four equations {e1, e2, e3, e4}, it is possible select some combinations (if the number of equations is relatively high) or use of all possible combinations. If the equation set with four equations with two unknowns in each, it is possible to divide the set e.g. into following subsets:

{e1, e2}, {e3, e4} (if no overlapping allowed) or {e1, e2}, {e2, e3}, {e3, e4} (if overlapping allowed).

In hyperbolic location calculation, number of equations in (1) can be relatively small. The inventor has found that although all possible combinations are used it is still possible to keep the complexity of the calculation is an acceptable level. In the above example this would mean that we would have subsets:

{e1, e2}, {e1, e3}, {e1, e4}, {e2, e3}, {e2, e4}, {e3, e4}.

More particularly, the proposed the E-DAC location calculation may be accomplished in the following manner. Let E={e₁,e₂ . . . , e_{M} be a set of RD equations as defined in equation (1), where eᵢ denotes a single RD equation and M is number of such equations. E is divided into

$$( \begin{matrix}M \\ N\end{matrix} ) \backslash [ autoleftmatch ]$$

different subsets with N equations in each, where N denotes dimension of space where location is calculated (i.e., 2 or 3). In other words, all possible subsets or {e₁,e₂ . . . e_{M}} with size of N (=2 or 3) are formed. Solution for each of those subsets is then calculated by an appropriate method. Results from the subsets are combined into one final result.

The DAC and E-DAC methods were also tested with the test arrangement that was already discussed in the context of FIGS. 4a and 4b. The results of these test are shown by tables 1 and 2 of FIG. 5. In the test the only difference between the two methods was that the equations were divided into subsets. In DAC, the equation set (1) was divided into overlapping subsets, and in E-DAC, all possible combinations were used.

Following statistical figures that were collected from the simulations are shown by Tables 1 and 2:

67% error=the smallest location error value which is bigger than the error in 67% of the cases.

90% error=the smallest location error value which is bigger than the error in 90% of the cases.

RMS90%=root-mean-square for 90% of the smallest location errors.

#rejections=number of cases in which a location estimate was not achieved.

Avg. FLO=average number of floating point operations per estimate.

The results show that the Enhanced DAC improves accuracy against ordinary DAC method. Improvement is more significant in a suburban environment. This is due to the fact that in the suburban areas the average number of RD measurements is less than in a urban environment (i.e., the number of equations in equation set (1) is smaller) and therefore difference in the combining approach was proven to be more significant. Also number of rejections was found co be smaller with the E-DAC than it was with ordinary DAC. The averaige number of floating point operations used per location estimation may be higher with the E-DAC. The accomplished test show that the proposed E-DAC method may provide good overall performance. In addition, the embodiment is relatively easy to implement since no matrix operations are necessary. The E-DAC method may be used in any location system that is based on range difference measurements.

The location information provided by the location server may be used for several purposes and the following are some examples of possible clients. The telecommunication system may use it for call processing (routing, charging, resource allocation, etc.). The service can be used to determine the location of a mobile station when an emergency call has been made from it. Clients may also be organizations that broadcast location related information to mobile stations in a particular geographic area—e.g. on weather, traffic, hotels, restaurants, or the like. These possible applications include different local advertisement and information distribution schemes (e.g. transmission of information directed to those mobile users only who are currently within a certain area), area related WWW-pages (such as time tables, local restaurant, shop or hotel guides, maps local advertisements etc.) for the users of mobile data processing devices, and tracking of mobile users by anyone who wishes to receive this information and is legally entitled to obtain it. Clients may also wish to record anonymous location information (i.e. without any MS identifiers)—e.g. for traffic engineering and statistical purposes. The location information may also be used for enhancing or supporting any supplementary service, IN (intelligent network) service, bearer service or teleservice subscribed to by the target mobile station MS subscriber. These are only examples and there are several other possible commercial and non-commercial applications which may use the location information provided by the location service (LCS).

Embodiments provide a method which may be used to improve the accuracy of location calculation algorithms. The embodiments are described in the context of mobile station location in the GSM networks, but it should be appreciated that the embodiment may be used in any other location service that is based on range difference measurements. It should also be appreciated that whilst embodiments of the present invention have been described in relation to mobile stations, embodiments of the present invention are applicable to any other suitable type of user equipment such as portable data processing devices or web browsers.

It is also noted herein that while the above describes exemplifying embodiments of the invention, there are several variations and modifications which may be made to the disclosed solution without departing from the scope of the present invention as defined in the appended claims.

1. A method in a communication system for providing location information of a wireless station, the method comprising:
accomplishing at least one measurement that may be used for determining the location of the wireless station by an element that associates with the communication system;
defining an estimate of the location of the wireless station based on the at least one measurement, wherein the estimate is defined by using at least one approximation;
subjecting the estimate to a non-linear measurement error minimisation routine; and
outputting location information of the wireless station based on the results of the minimisation routine.

2. A method as claimed in claim 1, wherein the minimisation routine uses at least one weighted value that is proportional to the reliability of the respective measurement.

3. A method as claimed in claim 2, wherein the reliability of the respective measurement is defined based on dispersion of the measurements.

4. A method as claimed in any preceding claim, wherein the minimisation routine comprises an additional weight function that is adapted to increase the value of a minimised function for locations that are outside of a predefined area of interest.

5. A method as claimed in any preceding claim, comprising at least one range measurement.

6. A method as claimed in any preceding claim, wherein at least two base stations of a cellular communication system are used for determining the measurement information.

7. A method as claimed in any preceding claim, comprising at least one range difference measurement.

8. A method as claimed in any preceding claim, wherein at least three base stations of the communication system are used for determining h:e measurement information.

9. A method as claimed in any preceding claim, wherein at least one measurement is accomplished by an element of a cellular communication network.

10. A method as claimed in any preceding claim, wherein at least one measurement is accomplished by the wireless station.

11. A method as claimed in any preceding claim, wherein the minimisation routine uses at least one vector consisting of equation errors.

12. A method as claimed in any preceding claim, wherein the location information is provided by a location service that associates with the communication system.

13. A method as claimed in any preceding claim, wherein the estimate of the location of the wireless station comprises division of the location co-ordinate function into a number of subsets, computing solutions for the subsets and combining said solutions.

14. A method as claimed in claim 13, wherein all possible subsets are formed, solved and combined to form a single location estimate.

15. A location system that associates with a cellular communication system for providing location information of a wireless station of the cellular communication system, the system comprising:
an element that associates with the cellular communication system for accomplishing at least one measurement that may be used for determining a location estimate for the wireless station;
a controller for defining the location estimate for the wireless station based on the at least one measurement, wherein the controller is adapted to use at least one approximation for the estimate, and for subsequently subjecting the estimate to a non-linear measurement error minimisation routine; and
interface means for outputting location information of the wireless station based on the results of the minimisation routine.

16. A location system as claimed in claim 15, wherein the controller is adapted to use at least one weighted value that is proportional co the reliability of the respective measurement in the minimisation routine.

17. A location system as claimed in claim 15, wherein the reliability of the respective measurement is defined based on dispersion of the measurements.

18. A location system as claimed in any or claims 15 to 17, wherein the controller is adapted to use an additional weight function for increasing the value of a minimised function for locations that are outside of a predefined area of interest.

19. A location system as claimed in any of claims 15 to 18, comprising at least three base stations of the cellular communication system.

20. A location system as claimed in any preceding claim, wherein at least one measurement is accomplished by the wireless station.

21. A wireless station for a communication system, the wireless station comprising:
means for handling information concerning at least one measurement that relates to the location of the wireless station;
a controller for defining a location estimate for the wireless station based on the information concerning the at least one measurement, the controller being adapted to subject the estimate to a non-linear measurement error minimization routine; and
interface means for outputting location information of the wireless station based on the results of the minimisation routine.

22. A wireless station as claimed in claim 21, wherein the means for handling the measurement information are adapted to accomplish at least one location measurement.

23. A wireless station as claimed in claim 21 or 22, wherein the means for handling the measurement information are adapted to receive information from the communication system for use in the step of defining the location estimate.

24. A wireless station as claimed in claim 23, wherein the received information comprises information of at least one location measurement accomplished by means of an element of the communication system.
